(19) United States
(12) Patent Application Publication
(10) Pub. No.: US 2018/0020697 A1
(43) Pub. Date: Jan. 25, 2018

(54) FEED IN THE FORM OF GEL FOR PIGLETS, METHOD OF MANUFACTURING THE SAME AND USE

(71) Applicant: EARLYPIG, Saint-gregoire (FR)

(72) Inventor: Hervé GABILLET, Lanouee (FR)

(21) Appl. No.: 15/551,219

(22) PCT Filed: Feb. 23, 2016
(86) PCT No.: PCT/IB2016/050963

§ 371 Date: Aug. 15, 2017

Related U.S. Application Data
(60) Provisional application No. 62/119,765, filed on Feb. 23, 2015.

(51) Int. Cl. A23K 40/00; A23K 50/60; A23K 20/195; A23K 50/30; A23K 20/163

(52) U.S. Cl. CPC A23K 40/00; A23K 50/30; A23K 20/163; A23K 20/195; A23K 50/60

(57) ABSTRACT

The present invention refers to a method of manufacturing a complete feed in the form of a gel for livestock and pets. The present invention particularly relates to a method of manufacturing a complete feed for piglets in the form of a gel, in particular for the first 10 days of life. It also relates to the formulated gel feed obtained therewith.

### TECHNICAL FIELD

The present invention refers to a method of manufacturing a complete feed for piglets in the form of a gel, in particular for the first 10 days of life. It also relates to the formulated gel feed obtained therewith.

Therefore, the present invention has utility in the field of livestock breeding.

### BACKGROUND OF THE INVENTION

Methods of providing a feed to piglets are widely known and practiced.

Such methods are rather specific, because piglets has not much interest in consuming feed but has particular nutritional needs. For example, transitional stages such as weaning pose nutritional problems since the young animal has to learn how to consume solid food. It is sometimes difficult for the piglets to get accustomed to nourishment other than by suckling. Early weaning provides advantages relating to avoidance of diseases and increased weight gain. However, care is needed in early weaning to ensure that the young animal consumes sufficient nutrients.

Unfortunately, known methods are not totally adapted to piglets, especially piglets from day 1 to day 10 of life. Indeed, feed for piglets often have a consistency that is difficult for piglets to consume.

Thus, a need exists of alternatives, more efficient and easy to implement. The present invention fulfills these and other needs.

### DESCRIPTION OF THE INVENTION

The present invention relates to a method of manufacturing a complete feed for piglets in the form of a gel (PorridGel™), in particular for the first 10 days of life. It also relates to the formulated gel feed obtained therewith.

The light consistency of the unstructured gel feed made by the method of the invention allows an easy intake for piglets without sticking.

The unstructured gel feed of the invention has a consistency adapted for an easy intake by piglets, especially piglets from day 1 to day 10 of life. It also has an adapted palatability for the piglets. Furthermore, the unstructured gel feed of the invention shows a good stability in time, that may reach over 2 years, which make this product particularly easy to use for the breeders.

The present invention also includes a method of feeding piglets with the unstructured gel made according to the method of the invention. The piglets can received the unstructured gel feed from day 1 to day 10, in particular weak or supernumerary piglets. The gel feed may also be provided in case of digestive disturbance for stabilization of water and electrolyte balance.

The method comprises forming a feed mixture by mixing hot water, a pectin base and a powder core of feed nutrient components after cooling. Once the feed mixture is formed, an acid core is prepared and included by mixing to the feed mixture such that a gel feed is formed which is further disintegrated and degassed such that an unstructured gel is obtained.

Accordingly, in a first aspect, the present invention provides a method for manufacturing a feed for piglets in the form of gel, said method comprising :
A) forming a feed mixture by (i) mixing hot water and a pectin base, (ii) cooling the mixture and (iii) adding a powder core of feed nutrient components to the cooled mixture ;
B) forming an acid core and including the same by mixing to the feed mixture such that a gel feed is formed ;
C) disintegrating and degassing the gel feed formed such that an unstructured gel feed is formed.

“Hot water” in step A) refers herein to a water having a temperature suitable for obtaining a mixture, preferably an homogenous mixture, of the pectin base in the water. The temperature of the water may be comprised of from about 65° C. to about 85° C., preferably of from about 70° C. to about 80° C. For example, the water may be at a temperature of about 80° C.

“Pectin base” or “pectin base composition” refers herein to a composition having pectin as major compononent. The pectin may be any kind of pectin, for example a Low Methoxyl Pectin (LM) or high methoxy pectin (HM). Pectin is used in the present invention as a gelling agent. Advantageously, pectin may be comprised of from about 50% (50 being advantageously excluded) to about 100% by weight of the total weight of the pectin base composition, for example of from 55 to 90%, or of from 60 to 85%, preferably about 85%.

Pectin base composition may also comprise at least one other component, chosen among xanthan, guar gum and locust bean gum (LBG, also known as carob gum, carob bean gum and carobin), Kelgum® (CP Kelco) and Kelgum GFS® (CP Kelco), for example in a concentration of from 0 to 50% (50 being advantageously exluded) by weight of the total weight of the pectin base composition, or of from 10 to 45%, or of from 15 to 40%, or of from 20 to 35%, preferably of about 15%.

For example, xanthan may be comprised of from 4 to 10% by weight of the total weight of the pectin base composition, for example from 5.5 to 8.5%, or preferably be of from 6.75 to 8.25% or from 6 to 7.5%. In one embodiment, the pectin base composition may comprise pectin, xanthane and locust bean gum. In another embodiment, the pectin base composition may comprise pectin, xanthane, guar gum and locust bean gum. For example, LBG may be comprised of from 2 to 10% by weight of the total weight of the pectin base, for example from 2.5 to 8.5%, or preferably be of from 6.75 to 8.25% or from 3 to 4.5%. For example, guar gum may be comprised of from 0 to 6% by weight of the total weight of the pectin base, for example be of from 3 to 6%.

Examples of pectin base formulations may be as follows:

| | | Approximate Weight |
|---|---|---|
| | | Percent On a Wet Basis |
| Composition | Component | in the pectin base |
| 1 | pectin | 100% |
| 2 | pectin | 50%-100% (excluding the |
| | | limits) |
| | xanthan | 0-50% (excluding the |
| | | limits) |
| 3 | pectin | 85% |
| | xanthan | 6.75-8.25% |
| | locust bean gum | 6.75-8.25% |
| 4 | pectin | 85% |
| | xanthan | 6-7.5% |
| | locust bean gum | 3-4.5% |
| | Guar gum | 3-6% |

Advantageously, the unstructured gel feed obtained of the present invention is sufficiently soft to be consumed easily by piglets. It has for example the consistency of a porridge, or a crushed Flam by®. The gel can be described as a hydrogel that is a colloidal gel in which water is a dispersion medium . One consideration in the consistency of the gel is that the gel does not stick to the piglets animal. Gel that sticks to the piglets poses two problems. The first problem relates to the cleanliness of the animal and to the pen in which the animal is contained. The other problem is waste of feed, since the animal cannot consume the feed that sticks to its face and other parts of the body—that are not reachable by the animal's mouth.

Advantageously, the major component of the unstructured gel of the invention is water. For example, water is at least 55% by weight of the total weight of the unstructured gel, for example from 55 to 75%. In this embodiment, the unstructured gel feed provides piglets with both a feed component and a water component to an extent that preferably no additional water external of the feed is needed for the piglets sustenance. For example, dry matter in the unstructured gel may be less than 45% weight percent of the total weight of the unstructured gel, for example 25 to 45%, or from 30-35%.

Pectin base composition used in the present invention may allow binding with water and/or is capable of forming a matrix in which the feed nutrient is retained. For example, the pectin base may be in a concentration of from 0.5 to 3.0% by weight of the total weight of the unstructured gel feed, for example of from 1.0% to 2.8%, or of from 1.3% to 2.7%, or of from 1.5% to 2.5%, or from about 1.7 to 2.3, or of about 2.0%.

For example, pectin is present in a concentration of from about 0.5% to 2.3% by weight of the total weight of the unstructured gel feed, for example of from 1.0 to 2.0, for example of about 1.7% of the total weight of the unstructured gel feed.

For example, the mixture comprising xanthan, or xanthan and LBG, or xanthan and LBG and guar gum is present at a concentration of from 0 to about 0.7% by weight of the total weight of the unstructured gel feed, for example from about 0.1 to 0.5%, for example of about 0.3%.

Preferably, pectin is present in a concentration of about 1.7% of the total weight of the unstructured gel feed, and the mixture comprising xanthan, or xanthan and LBG, or xanthan and LBG and guar gum is present at a concentration of about 0.3%.

“Feed nutrient” refers herein to a composition comprising nutrient allowing growth of piglets. It may refer to at least one of the following components: proteins, carbohydrates, fat, fibers and vitamines.

Suitable sources for protein useful in the composition of the present invention include both animal and plant based protein. A non-exhaustive list of plant based protein includes whey protein concentrate, wheat flour, pea protein, potato protein, fermented potato protein, soya protein concentrate, alfalfa meal, canola seed meal, rice protein, coconut meal (copra), wheat gluten, cotton seed meal, linseed meal (flax), peanut meal, safflower meal, sesame meal, soybean meal, soybean proteins and sunflower meal and other oil seed meals.

Sources for carbohydrates useful in the present invention include sorgum flour, ground rice, rice flour, ground corn, oat products, wheat, ground sorgum, or starch from any suitable grain such as wheat, oats, barley, and triticale, or tubers such as tapioca, and potato. Lactose, dextrin, sucrose, fructose and other simple sugars are also suitable carbohydrates.

Fat useful in the present invention may come from both plant or animal sources. Some fat may be the result of inclusion in the protein or carbohydrate source. However, additional fat may be added and is typically a rendered product such as a blended fat (animal and vegetable blends), or may be a poultry fat or tallow or a vegetable source such as soybean oil, com oil, canola oil, coconut oil, olive oil, palm oil, copra oil and the like. Fat is necessary as a source of energy and also in the assimilation of certain vitamins that may be added to the feed of the present invention.

Fiber useful in the present invention is dietary fiber. Principal sources of dietary fiber are the same plant sources that provide protein and/or carbohydrates. If additional dietary fiber is needed, it may be obtained from such typical sources as soybean hulls or psyllium.

In addition to the nutrients discussed above, it may be desirable to provide additional supplementation of vitamins and minerals depending on the needs of the particular animal.

In one embodiment, the gel feed of the present invention may be used as a delivery system for medication such as antibiotics and chemotherapeutics or for microbial supplements such as probiotics and nutraceuticals. When used as a delivery system for medication, the medication may be the sole constituent in the gel. Examples of antibiotics approved for swine include apramycin, bacitracin methylene disacylate, bacitracic zinc, bambermycins, chlortetracycline, lincomycin, neomycin, oxytetracycline, penicillin, tiamulin, tylosin, and virginiamycin. Chemotherapeutics approved for swine include arsanilic acid, carbodox, roxarsone, sulfamethazine and sulfathiazole.

“Acid core” refers herein to any organic acid that may allow to obtain a pH comprised of from about 3.6 to 4.2. At least one acid core may be used. Acid cores may be under the form of a liquid and/or of a powder.

Another object of the present invention is a non-therapeutic method of feeding piglets, said method comprising:
forming a feed mixture by (i) mixing hot water and a pectin base (ii) cooling the mixture and (iii) adding a powder core of feed nutrient components to the cooled mixture ;
forming an acid core and including the same by mixing to the feed mixture such that a gel feed is formed ;
disintegrating and degassing the gel feed formed such that an unstructured gel feed is formed ;
feeding the piglets with the unstructured gel feed, wherein the unstructured gel feed does not contain any medication.

In other words, the non-therapeutic method of feeding piglets comprising the steps of:
a) making a feed for piglets in the form of gel, as described above, that does not contain any medication; and
b) feeding said piglets with the feed.

All the definitions and embodiments described above in relation with the method for manufacturing a feed for piglets in the form of gel are also suitable for this aspect of the invention.

According to the invention, piglets are advantageously less than 11 days of age. They may be for example of from 1 to 10 days of life.

Another object of the invention is an unstructured feed gel obtainable by the method as described above.

Another object of the invention is an unstructured feed gel comprising a pectin base, said pectin base comprising pectin, xanthan and guar gum or locust bean gum.

Another object of the invention is the unstructured feed gel as described above for use in the treatment of piglets by feeding said unstructured feed gel to said piglets, wherein the unstructured feed gel is made according to the method of the invention and the unstructured feed gel contains medication.

Another object of the invention relates to a pectin base composition, comprising pectin, or pectin and xanthan, or pectin and xanthan and locust bean gum, or pectin and xanthan and locust bean gum and guar gum.

This invention is further illustrated by the following examples with regard to the annexed drawings that should not be construed as limiting.

### EXAMPLES

### Example 1

### Method of Making the Gel Feed EarlyStart for Piglets

Cycle time/batch: 2H

| Phases | Instructions | Designation steps |
|---|---|---|
| 1. Loading water | Water meter: 400 | Loading of 400 liters of hot water |
| | liters | |
| | | End loading 400 liters hot water |
| 2. Loading of the | Vacuum pump to | Starting vacuum to suction of the |
| liquid core | start | liquid core: vacuum setpoint: −0,5b |
| | Vacuum: −0,5b | Suction of the liquid core and rinsing |
| | | piping with 2 liters of water |
| | | Stop vacuum and returned to |
| | | atmosphere of the mixture |
| 3. Pectin base | Paddle stirrer in | Starting paddle stirrer |
| manufacturing | running: | |
| | Speed 26 Hz | |
| | | Loading pectin powder by the vacuum |
| | | bags hopper |
| | | End loading pectin powder |
| | Dispersers in | Starting dispersers |
| | running | |
| | Water meter: 70 | Adding 70 liters of hot water by the |
| | liters | vacuum bags hopper: rinsing powder |
| | | on the shaft of the paddle stirrer |
| | Vacuum pump to | Starting vacuum for degassing pectin |
| | start | base: vacuum setpoint: −0.5b |
| | Vacuum: −0,5b | Start mixing pectin base-time of |
| | time of mixture: | mixture setpoint: 10 mn |
| | 10 mn | |
| | After 10 mn of | Stop mixing, stop vacuum and |
| | mixture under | returned to atmosphere of the mixture |
| | vacuum | |
| | Temperature control | State value of temperature of the |
| | of mixture | pectin mixture: setpoint: 10° C. < |
| | | 70° C. < T° C. < 80° C. (document ref. |
| | | PRO-EN01v1) |
| 4. Cooling pectin | Cold water | Cold water circulation jacket to reduce |
| base | circulation jacket | temperature of the pectin base |
| | Paddle stirrer | Starting paddle stirrer |
| | running: speed | |
| | 26 Hz | |
| | After 20 mn of | State value of temperature of the |
| | cooling, control | pectine mixture: setpoint: 10° C. < |
| | temperature of the | 10° C. < T° C. < 17° C. (document ref. |
| | mixture | PRO-EN01v1) |
| 5. Loading powders | Padle stirrer in | Starting paddle stirrer |
| core | running: | |
| | Speed 26 Hz | |
| | | Loading powders by vacuum bags |
| | | hopper |
| | | End loading powders, closure valve of |
| | | vacuum bags hoper |
| | Speed paddle | Increasing speed of paddle stirrer, |
| | stirrer: 50 Hz | starting dispersers and mixture during |
| | Dispersers in | 10 mn |
| | running | |
| | Mixing time: 10 mn | |
| | After 10 mn of mixing | Stop agitations |
| | Temperature control | State value of mixture temperature: |
| | of mixture | setpoint: 10° C. < T° C. < 17° C. |
| | | (document ref. PRO-EN01v1) |
| 6. Preparation of | Water meter: 40 | Loading 40 liters f cold water in the |
| acids core | liters | stirred tank of 60 liters |
| | | End loading 40 liters cold water |
| | | Loading liquid acids in the stirred tank |
| | | of 60 liters |
| | | End loading liquid acids |
| | Pneumatic agitator | Starting pneumatic agitator on tank of |
| | in running-speed: | 60 liters and adjusting stirring speed |
| | valve 1/3 | |
| | | Loading powder acids under agitation |
| | | End loading of powder acids, closure |
| | | and clamping the lid of the stirred tank |
| | Speed pneumatic | Increasing speed of agitation in the |
| | agitator-speed: | tank of 60 liters, time of mixing: 2 mn |
| | valve opened to the | minimum, the time to carry out |
| | maximum | adjustment on the control cabinet |
| 7. Adjustment of | Switch of dispersers | Switch of the switch of dispersers on |
| parameters to include | in “off” position | “off” position in front of the control |
| acids core | | cabinet |
| | Mixer clock set at | Adjust the operation time clock of the |
| | 30s | paddle stirrer on 30 s |
| | Potentiometer | Adjust the potentiometer speed of the |
| | speed of the paddle | paddle stirrer on 10 |
| | stirrer set at 10 | |
| 8. Incorporation of | Paddle stirrer in | Starting the paddle stirrer |
| the acids core | running: | |
| | Speed 50 Hz | |
| | Opening the drain | Incorporation under agitation of the |
| | valve of the stirred | acids solution by quick opening of the |
| | tank of 60 liters, | drain valve of the stirred tank of 60 |
| | time of mixture 30 | liters |
| | seconds | |
| | | End incorporation acids solution, stop |
| | | pneumatic agitator and closure of the |
| | | drain valve |
| | After 30 seconds of | Stop the paddle stirrer and beginning |
| | mixing at 50 Hz | of the gelation in static |
| | Temperature control | State value of the mixture |
| | of the mixture | temperature: setpoint: |
| | | 10° C. < T° C. < 17° C. (document ref. |
| | | PRO-EN01v1) |
| 9. Gelation | Time of gelation: | Time of gelation of the mixture in |
| | 50 mn | static: 50 mn. Note the start time of |
| | | gelation |
| 10. Adjustment of | Clock of mixer set at | Adjust the operation time clock of the |
| parameters for | 120 s | paddle stirrer on 120 seconds |
| disintegration of gel | Potentiometer | Adjust potentiometer speed of the |
| | speed of the paddle | paddle stirrer between 1 and 2 |
| | stirrer set between 1 | |
| | and 2 | |
| | Switch of dispersers | Make sure that the switch of the |
| | in “off” position | dispersers is in “off” position |
| 11. Disintegration of | Paddle stirrer | Beginning paddle stirrer |
| the gel | running: | |
| | Speed 13 Hz | |
| | Mixture time: 4 mn | |
| | After 4 mn of | Stop paddle stirrer, end of |
| | disintegration | disintegration |
| 12. Degassing | Stop air bearings | Close the air flow control knobs on the |
| unstructured gel | | bearings of the paddle stirrer and on |
| | | the bearings of dispersers |
| | Vacuum pump to | Starting vacuum for degassing |
| | start | unstructured gel: vacuum setpoint: −0.4b |
| | Vacuum: −0.4b- | Beginning of degassing of the |
| | degassing time: | unstructured gel-setpoint of |
| | 3 mn | degassing time: 3 mn at −0.4b |
| | After 3 mn of | Stop vacuum and gently return the |
| | degassing at −0.4b | tank to atmosphere |
| | Temperature control | State value of the mixture |
| | of the mixture | temperature: setpoint: |
| | | 10° C. < T° C. < 17° C. (document ref. |
| | | PRO-EN01v1) |
| 13. Drain to the | Open drain valve | Switch the valve switch in “on” |
| production lines | under mixer tank | position at the front of the control |
| | | cabinet |
| | Product quality | Take a sample of the unstructured gel |
| | control | for quality control (see sheet ref. PDT- |
| | | EN01v1) |
| 14. Homogenizing of | Opening air | Open and adjust the air flow control |
| the unstructured gel: to | bearings | knobs on the bearings of the paddle |
| make when remains | | stirrer and on the bearings of |
| about 1/4 of product in the | | dispersers |
| mixer and end of draining | Clock of the mixer | Adjust the operation time clock of the |
| | set at 60 seconds | paddle stirrer on 60 s |
| | Switch of dispersers | Make sure that the switch of |
| | in “off” position | dispersers is in “off” position |
| | Paddle stirrer | Starting paddle stirrer |
| | running: | |
| | Speed 13 Hz | |
| | Mixture time: 1 mn | |
| | After 1 mn of | Stop paddle stirrer |
| | homogenizing at | |
| | 13 Hz | |
| | Stop air bearings | Close the air flow control knobs on the |
| | | bearings of the paddle stirrer and on |
| | | the bearings of dispersers |
| 15. End of draining, | | See instructions notice ref. N&D |
| rinsing, washing | | IN01v0 |

### Example 2

### Examples of Gel Feed for Piglets Made by the Method of Example 1

EARLYSTART: Complete Feed in the Form of Gel for the First 10 Days of Life. An Innovative and Comprehensive Solution for Feeding Your Piglets from Day 1 to Day 10

Product:

Direction for use Open one tray and put it on the floor of the farrowing pen. The first tray will last 2 to 3 days as the average intake per litter and per day is approx. 100 g during the 2 to 3 first days of life. When the tray is empty, open one new tray or refills it with our eco-friendly pouch*. The average intake per litter during 10 days will be 6 trays (or 1.2 kg). (* you can also use your standard feeder for distributing EARLYWEAK)

Composition Whey protein concentrate, wheat flour, pea protein, dextrose, lactose, wheat gluten, glycerol, vegetables oils (medium chains fatty acids), soya oil, maltodextrin, potato protein, dicalcium phosphate, fermented potato protein, tetrasodium diphosphate, salts of fatty acids, yeast cell walls (MOS and Beta Glucans), soya flour, pectin, DHA.

Analytical constituents Dry matter: 30.1% , Crude protein: 5.4% , Crude oils and fats: 4.0%, Crude ash: 2.2% , Crude fibre: 0.5%, Lysine: 0,5%, Methionine: 0.2% , Threonine: 0.3% , Tryptophane: 0.1% , Calcium: 0.1%, Phosphorus: 0.1%, Sodium: 0.3%.

Additives Nutritional additives • Vitamins: E672 Vitamin A: 7390 UI/Kg, E671 Vitamin D3: 740 UI/Kg, 3a700 Vitamin E: 142 mg/Kg, Vitamin C: 370 mg/ Kg • Trace elements: 3b8.11 Selenomethionine produced by Saccharomyces cerevisiaie NCYC R397: 0.25 mg/Kg. Technological additives • Preservatives: E202 Potassium sorbate, E280 Propionic acid,

E297 Fumaric acid, E330 Citric acid • Acidity regulator: E331 Tri sodium citrate • Antioxidant: E321 Butylated hydroxytoluene: 0.01% • Emulsifiers/Stabilisers/Thickeners: E415 Xanthan gum, E490 1,2 Propandiol: 7318 mg/Kg. Sensory additives Flavouring compound (vanilla), Green tea extract: 0.02%.

Shelf life 2 years in original packing • store at ambient temperature and out of direct sunlight.

Packaging

Tray of 235 g (net weight 200 g)

Eco-friendly Pouch 5 Kg (25 doses of 200 g)

Study :

The study was carried out on 427 piglets from 35 sows (LW LR Pietrain) randomly assigned to 2 batches only differing by diet :
a first batch CONTROL (18 sows, 213 piglets having an average weight at day 0 of 1.248g and of which 46.009% were female) only receiving mother's milk from day 0 to day 10 then lactation (no food is distributed to the piglets or conventional livestock feed) ;
a second batch EARLYSTART (17 sows, 214 piglets having an average weight at day 0 of 1.310 g and of which 52.336% were female) receiving mother's milk and the complete feed EarlyStart (200 g per day and litter in a little preconditioned tray) from day 0 to day 10 then lactation (no food is distributed to the piglets or conventional livestock feed). The average consumption of the complete feed EarlyStart was 10 g/piglet/day during 10 days, then about 1143 g per litter. The consumption may be low on the first days. Then consumption may increase up to 3 times the initial consumption.

Sows were matched according to the rank and the litter size. The 35 sows selected for this study were randomly assigned to one of the two batches.

Piglets were weighed individually at days 0, 11 and 21. For the batch EarlyStart, the amount of complete feed EarlyStart ingested was measured daily for each litter from day 0 to day 10. The monitoring of mortality was conducted throughout the duration of the study with recording of dead animals.

The main criteria of the study were:
daily weight gain (DWG) at weaning. A calculation of the average daily gain was done for each litter, to compare the two batches.
homogeneity of litters.

The secondary criteria were:
daily weight gain (DWG) from day 0 to day 11. A calculation of the average daily gain was done from day 0 to day 11 for each litter, to compare the two batches.
mortality between farrowing and weaning.
relationship between growth and feed intake.

The experimental unit is the litter (DWG, feed intake) and the piglet (mortality). Regarding statistical tests, DWG was subjected to analysis of variance (ANOVA) to 1 factor (group) for the comparison of the two batches with the sow as a factor nestled in the group with the number of piglets of the litter as an adjustment variable. The homogeneity of litters was tested by calculating the standard deviation of each litter as a variable. Mortality was compared between batches using a Pearson's chi-square test.

Properties :
A decrease of the mortality before weaning (7.5% vs 14.60%=−48%, compared to piglets only receiving mother's milk).
An increase of the average daily gain (ADG) at day 11 of +14% and from birth until weaning of +20%, compared to piglets only receiving mother's milk).
A return on investment of more than 70 [symbol] per sow per year, only based on the effect of the complete feed EarlyStart (without taking into account the 20% improvement of ADG).

EARLYWEAK: Complete Feed for Weak Piglets in the Form of Gel for the First 10 Days of Life. A Tailored Solution for Feeding Your Weak or Supernumerary Piglets from Day 1 to Day 10.

Direction for use Open one tray and put it on the floor of the farrowing pen. When the tray is empty, open one new tray and replace the empty one; or refill the empty tray with our eco-friendly pouch*. EARLYWEAK is ready to use and easy to handle. (* you can also use your standard feeder for distributing EARLYWEAK)

Composition Soya protein concentrate, protein whey, skimmed milk, soya oil, vegetable oils (medium chains fatty acids), dextrose, lactose, maltodextrin, wheat gluten, sugar, demineralized whey, palm oil, brewer's yeast, copra oil, soya-isolate, potato protein, dicalcium phosphate, glycerol, fermented potato protein, pre-gelatinized starch, soya flour, tetrasodium diphosphate, salts of fatty acids (calcium butyrate), yeast cell walls (MOS and Beta Glucans), pectin, algae extracts.

Analytical constituents Dry matter: 35%, Crude protein: 7.0%, Crude oils and fats: 7.0%, Crude ash: 1.2%, Crude fibre: 0.2%, Lysine: 0.6%, Methionine: 0.3%, Threonine: 0.4%, Tryptophane: 0.15%, Calcium: 0.20%, Phosphorus: 0.15%, Sodium: 0.37%.

Additives Nutritional additives • Vitamins : E672 Vitamin A: 7315 UI/Kg, E671 Vitamin D3: 732 UI/Kg, 3a700 Vitamin E: 139 mg/Kg, Vitamin C: 366 mg/Kg • Trace elements: 3b8.11 Selenomethionine produced by Saccharomyces cerevisiaie NCYC R397: 0.25 mg/Kg • Technological additives • Preservatives: E202 Potassium sorbate, E280 Propionic acid, E297 Fumaric acid, E327 Calcium lactate, E330 Citric acid • Antioxidant: E321 Butylated hydroxytoluene: 0.01% • Acidity regulator: E331 Tri sodium citrate • Emulsifiers/Stabilisers/Thickeners: E322 Lecithin, E415 Xanthan gum. Sensory additives Flavouring compound (vanilla), Green tea extract : 0.02%

Shelf life 2 years in original packing • store at ambient temperature and out of direct sunlight.

Packaging

Tray of 235 g (net weight 200 g)

Eco-friendly Pouch 5 Kg (25 doses of 200 g)

Properties :
A decrease of the mortality before weaning
An increase of the average daily gain (ADG) from birth until weaning.
A better homogeneity of litters.

EARLYGUT: Nutritional Supplement in the Form of Gel in Case of Digestive Disturbance. A Special Formulated Gel for use During Digestive Disorders

Particular nutritional purpose Stabilisation of water and electrolyte balance.

Direction for use In case of risk or, during periods of recovery from digestive disturbance, open one tray (or fill a tray with an eco-friendly pouch) and put it on the floor of the farrowing pen. Feed 200 g per day and per litter, during 2 days. EARLYGUT is ready to use and easy to handle.

Composition Dextrose, attapulgite, soya protein concentrate, vegetable oils (medium chains fatty acids), salt, lignocellulose, brewer's yeast, tetrasodium disphosphate, dicalcium phosphate, chicory inulin, calcium salts of fatty acids (calcium butyrate), magnesium oxide, potassium chloride, yeast cell wall, pectin, DHA.

Analytical constituents Dry matter: 35%, Crude protein: 4.8%, Crude oils and fats: 1.9%, Crude ash: 10.4%, Crude fibre: 1.3%, Lysine: 0.4%, Methionine: 0.2%, Threonine: 0.3%, Tryptophane: 0.1%, Calcium: 0.20%, Phosphorus: 0.05%, Sodium: 1.8%.

Additives Nutritional additives • Vitamins: E672 Vitamin A: 14645 UI/Kg, E671 Vitamin D3: 1465 UI/Kg, 3a700 Vitamin E: 168mg/Kg, Vitamin C: 732 mg/Kg • Trace elements: 3b8.11 Selenomethionine produced by Saccharomyces cerevisiaie NCYC R397: 0.25 mg/Kg Technological additives • Preservatives: E202 Potassium sorbate, E280 Propionic acid, E297 Fumaric acid, E330 Citric acid, E281 sodium propionate • Antioxidant: E321 Butylated hydroxytoluene: 0.01% • Acidity regulator: E331 Tri sodium citrate • Emulsifiers/Stabilisers/Thickeners: E415 Xanthan gum. Sensory additives Flavouring compound (vanilla), Tannin extract of chestnut tree, Sanguinarine, 2b) Monosodium Glutamate.

Shelf life 2 years in original packing—store at ambient temperature and out of direct sunlight.

Packaging

Tray of 235 g (net weight 200 g)

Eco-friendly Pouch of 5 Kg (25 doses of 200 g)

Properties :

Attapulgite clay A non-expandable clay with a positive action on the protection of enterocytes, reducing inflammation of the bowels' surface and toxin binding.

Soya protein concentrate A protein derived from soybeans, very rich in essential amino acids and enzymatically processed; the product, featuring small-sized proteins, is free of allergenic effects and any standard soybean antinutritional factors, therefore offering optimum digestibility.

Natural fiber Purified cellulose that contributes to regulating the digestive transit, particularly in the event of digestive problems. Because it is not absorbed through the bowels, it helps preserve polymeric structures in fecal matter, inducing drier feces.

Sodium glutamate The preferred source of energy for the enterocytes it promotes the quick reconstitution of the intestinal flora following stress. DHA The most important omega-3 fatty acid that regulates the balance between ecosanoid hormones, prostaglandins, thromboxanes and leukotrienes.

Calcium butyrate Calcium butyrate affects the bowels' maturation, helps regulate the immune system and controls pathogen flora by regulating the production of digestive hormones (gastrin, ghrelin, etc.) and the maturation of the digestive nervous system. It is also a milk component recognized by piglets, which stimulates their feed consumption.

Sanguinarine It is a natural anti-inflammatory from the alkaloid family, it has a beneficial action against pathogen bacteria.

Tannin extracted from chesnut tree A hydrolysable polyphenol that activates the intestinal mucus layer, beneficial for intestinal cell protection and offering additional positive action by reducing the body's oxidation.

Inulin A FOS source, this prebiotic contributes to the development of a balanced digestive flora by stimulating bifidobacteria and inhibiting pathogens.

Premium yeast cell wall rich in MOS(mannan-oligosaccharides) and Beta Glucans having a strong impact on the immune system.

Dextrose is the simplest and most important sugar, its digestion requires no enzymes. It helps balance the fundamental hormonal regulation process by regulating insulin levels.

Betaine A molecule that helps the intestines fight hydric instability, such as water loss during diarrhea.

Vitamins A,D3,E,C Hydro-and liposoluble vitamins are essential for the piglets' metabolism.

Lysine, Methionine, L Threonine, Tryptophane The main essential amino acids are : lysine for growth and enzymatic activities; methionine for liver metabolism and muscle deposition; threonine for the immune system's development and tryptophane (a precursor of serotonin) for feed intake stimulation.

Vanilla aroma and sweetener Palatability and attractiveness are essential to stimulate voluntary feed intake.

Magnesium oxide A source of magnesium, an important mineral in cells, necessary to compensate the losses that occur during diarrhea.

Potassium chloride Provides potassium, an essential mineral in intestinal cells, and helps maintain the product's mineral balance.

Potassium sorbate An interesting source of energy with antibacterial and antifungal activity, potassium sorbate also contributes, combined with trisodium citrate, to regulating the acid-base balance.

Propionic acid a very specific monocarboxylic acid, a source of energy for animals and a strong antibacterial and antifungal component.

Citric acid, fumaric acid Two powerful acidulants that stimulate salivation and reduce pH, in order to reach a pH value allowing good preservation and optimum digestion in the animals' bowels.

### Example 3

### Example of Unstructured Gel Feed for Piglets

An unstructured gel feed as described in example 2 is realized by using the method described in example 1, and with the pectine base composition as follows:

| Component | Approximate Weight Percent On a Wet Basis |
|---|---|
| pectin | 85% |
| xanthan | 15% |

The unstructured gel feed obtained has a good stability in time.

The unstructured gel feed is used to feed piglets aged from 1 to 10 days of life.

Feed intake is excellent, with an excellent digestion of the unstructured gel feed.

No particular animal loss is noted, and no particular health problem is observed.

### Example 4

### Example of Unstructured Gel Feed for Piglets

An unstructured gel feed as described in example 2 is realized by using the method described in example 1, and with the pectine base composition as follows:

| Component | Approximate Weight Percent On a Wet Basis |
|---|---|
| pectin | 85% |
| xanthan | 6.75-8.25% |
| locust bean gum | 6.75-8.25% |

The unstructured gel feed obtained has a good stability in time.

The unstructured gel feed is used to feed piglets aged from 1 to 10 days of life.

Feed intake is excellent, with an excellent digestion of the unstructured gel feed.

No particular animal loss is noted, and no particular health problem is observed.

### Example 5

### Example of Unstructured Gel Feed for Piglets

An unstructured gel feed as described in example 2 is realized by using the method described in example 1, and with the pectine base composition as follows:

| Component | Approximate Weight Percent On a Wet Basis |
|---|---|
| pectin | 85% |
| xanthan | 6-7.5% |
| locust bean gum | 3-4.5% |
| Guar gum | 3-6% |

The unstructured gel feed obtained has a good stability in time.

The unstructured gel feed is used to feed piglets aged from 1 to 10 days of life.

Feed intake is excellent, with an excellent digestion of the unstructured gel feed.

No particular animal loss is noted, and no particular health problem is observed.

### Example 6

### Example of Unstructured Gel Feed for Piglets

An unstructured gel feed as described in example 2 is realized by using the method described in example 1, and with the pectine base/unstructured gel composition composition as follows:

| | Approximate | Approximate weight |
|---|---|---|
| | Weight | percent in the |
| | Percent in the pectin | unstructured gel |
| Component | base composition | composition |
| pectin | 85% | 1.7 |
| Kelgum ® (CP | 15% | 0.3 |
| Kelco): | | |
| 45-55% LBG | | |
| 45-55% xanthan | | |

The unstructured gel feed obtained has a good stability in time.

The unstructured gel feed is used to feed piglets aged from 1 to 10 days of life.

Feed intake is excellent, with an excellent digestion of the unstructured gel feed.

No particular animal loss is noted, and no particular health problem is observed.

### Example 7

### Example of Unstructured Gel Feed for Piglets

An unstructured gel feed as described in example 2 is realized by using the method described in example 1, and with the pectine base/unstructured gel composition composition as follows:

| | Approximate | Approximate weight |
|---|---|---|
| | Weight | Percent in the pectin |
| | percent in the | unstructured gel |
| Component | base composition | composition |
| pectin | 85% | 1.7 |
| Kelgum ® GFS (CP | 15% | 0.3 |
| Kelco): | | |
| 40-50% xanthan | | |
| 20-30% LBG | | |
| 20-40% guar gum | | |

The unstructured gel feed obtained has a good stability in time.

The unstructured gel feed is used to feed piglets aged from 1 to 10 days of life.

Feed intake is excellent, with an excellent digestion of the unstructured gel feed.

No particular animal loss is noted, and no particular health problem is observed.

1) A method for manufacturing a feed for piglets in the form of gel, said method comprising :
forming a feed mixture by mixing hot water and a pectin base and adding a powder core of feed nutrient components after cooling ;
forming an acid core and including the same by mixing to the feed mixture such that a gel feed is formed ;
disintegrating and degassing the gel feed formed such that an unstructured gel feed is formed.

2) A non-therapeutic method of feeding piglets, said method comprising:
forming a feed mixture by mixing hot water and a pectin base and adding a powder core of feed nutrient components after cooling ;
forming an acid core and including the same by mixing to the feed mixture such that a gel feed is formed ;
disintegrating and degassing the gel feed formed such that an unstructured gel feed is formed ;
feeding the piglets with the unstructured gel feed.

3) A method according to anyone of claim 1 or 2, wherein said pectin base also comprises xanthan.

4) A method according to claim 3, wherein said pectin base also comprises locust bean gum.

5) A method according to claim 4, wherein said pectin base also comprises guar gum.

6) The method according to claim 2, wherein the piglets are less than 11 days of age.

7) The method of any one of claims 1 and 3 to 6 wherein antibiotics or chemotherapeutics are added when the feed mixture is formed.

8) An unstructured feed gel obtainable by the method of anyone of claims 1 and 3 to 7.

9) An unstructured feed gel as defined in claim 8, for use in the treatment of piglets by feeding said unstructured feed gel to said piglets, wherein the unstructured feed gel is made according to the method of claim 7 and the unstructured feed gel contains medication.

10) A pectin base composition, comprising pectin and xanthan.

11) A pectin base composition, according to claim 10, also comprising locust bean gum and eventually guar gum.

12) A pectin base composition according to claim 11, comprising about 85% by weight of pectin, about 5.5 to 8.5% by weight of xanthan, about 2.5 to 8.5% by weight of locust bean gum and about 0 to 6% of guar gum, with reference to the total weight of the pectin base composition.
